(19) United States
(12) Patent Application Publication
(10) Pub. No.: US 2025/0168346 A1
(43) Pub. Date: May 22, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Lei ZHAO, Beijing (CN); Kai ZHANG, Los Angeles, CA (US); Li ZHANG, Los Angeles, CA (US)

(21) Appl. No.: 19/031,001

(22) Filed: Jan. 17, 2025

Related U.S. Application Data
(63) Continuation of application No. PCT/CN2023/107950, filed on Jul. 18, 2023.

(30) Foreign Application Priority Data
Jul. 19, 2022 (WO) PCT/CN2022/106497

(51) Int. Cl. H04N 19/13; H04N 19/159; H04N 19/176

(52) U.S. Cl. CPC H04N 19/13; H04N 19/159; H04N 19/176

(57) ABSTRACT

Embodiments of the present disclosure provide a solution for video processing. A method for video processing is proposed. The method comprises: determining, for a conversion between a current video block of a video and a bitstream of the video, at least one context model associated with the current video block based on initiation information of the at least one context model, the initiation information of the at least one context model being included in the bitstream; and performing the conversion based on the at least one context model.

### CROSS REFERENCE TO RELATED APPLICATIONS

This application is a continuation of International Application No. PCT/CN2023/107950, filed on Jul. 18, 2023, which claims the benefits of International Application No. PCT/CN2022/106497 filed on Jul. 19, 2022. The entire contents of these applications are hereby incorporated by reference in their entireties.

### FIELD

Embodiments of the present disclosure relates generally to video coding techniques, and more particularly, to context model determination.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, for a conversion between a current video block of a video and a bitstream of the video, at least one context model associated with the current video block based on initiation information of the at least one context model, the initiation information of the at least one context model being included in the bitstream; and performing the conversion based on the at least one context model. The method in accordance with the first aspect of the present disclosure determines the context model based on initiation information of the context model in the bitstream. Compared with the conventional solution, the proposed method in the first aspect can advantageously improve the coding effectiveness and coding efficiency.

In a second aspect, an apparatus for processing video data is proposed. The apparatus for processing video data comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining, based on initiation information of at least one context model, the at least one context model associated with a current video block of the video, the initiation information of the at least one context model being included in the bitstream; and generating the bitstream based on the at least one context model.

In a fifth aspect, a method for storing a bitstream of a video is proposed. The method comprises: determining, based on initiation information of at least one context model, the at least one context model associated with a current video block of the video, the initiation information of the at least one context model being included in the bitstream; generating the bitstream based on the at least one context model; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a flowchart for decoding a bin in HEVC;

FIG. 5 illustrates a flowchart for decoding a bin in VVC;

FIG. 6 illustrates a flowchart of a method for video processing in accordance with some embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

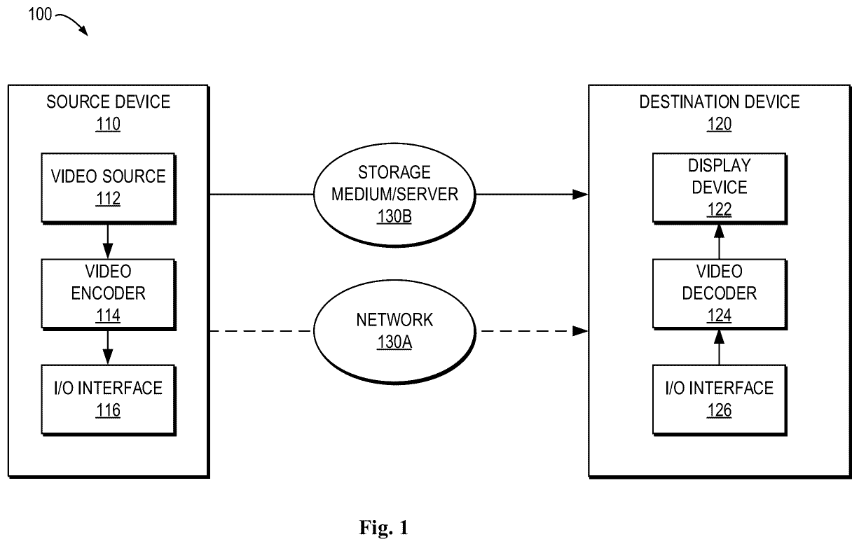

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

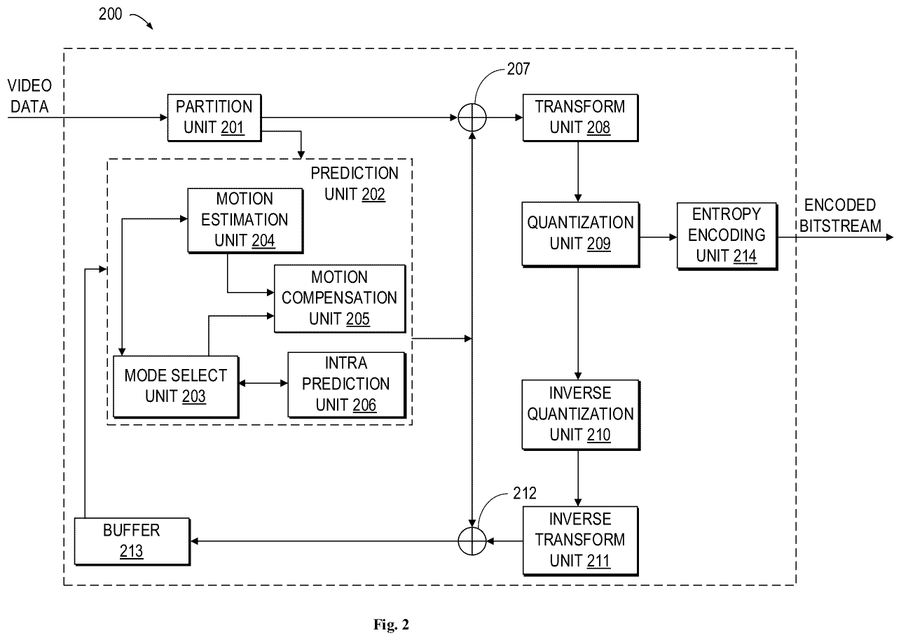

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

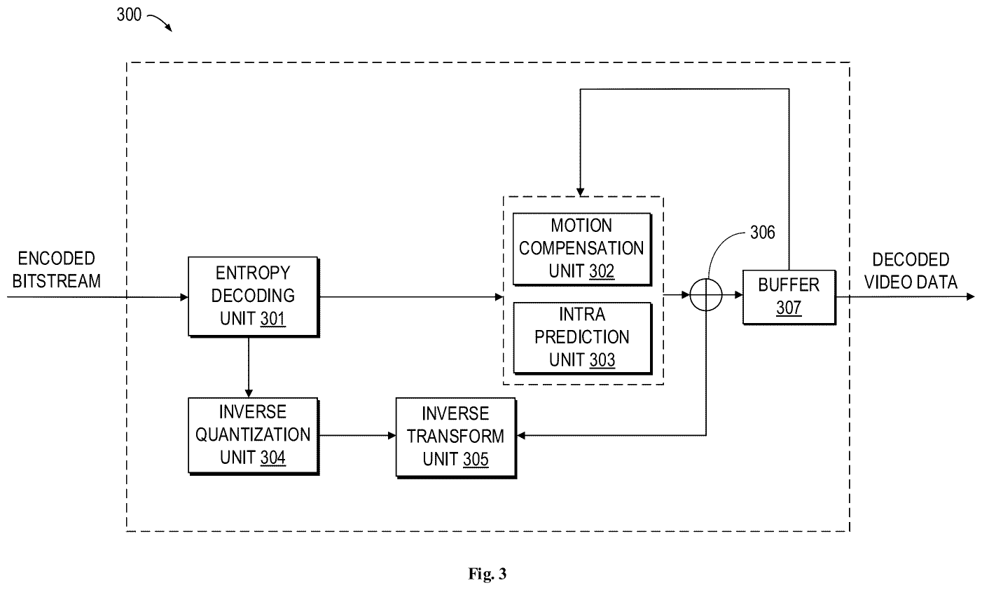

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about context signalling and initialization method in video coding. The ideas may be applied individually or in various combination, to any video coding standard or non-standard video codec.

### 2. Introduction

### 2.1. Entropy Coding

Entropy coding aims to remove the entropy redundancy in video signals, which is normally realized by taking advantage of conditional entropy and joint entropy. Accurate probability distribution estimation (i.e., context modelling) of the source symbols is a critical prerequisite for efficient entropy coding. Existing entropy coding technology can be roughly categorized to variable length coding (VLC) and arithmetic coding (AC), wherein Huffman coding is a typical VLC method, and has been adopted in early video coding standards such as mpeg-1, mpeg-2 and h.263. The basic idea of VLC is to allocate shorter codewords to those symbols with high occurrence probability and hence reduce the average code bits. Apart from Huffman coding, some other VLC methos, such as exponential Golomb code (ECG), Golomb Rice code (GRC) and context based variable length coding (CAVLC), are also broadly investigated in various video coding standards. Different from VLC, Arithmetic coding maps a sequence of source symbols to a positive real number ranging from 0 to 1, and uses a binary decimal within the range to represent the symbol sequence. As a successful application of arithmetic coding in field of video compression, context based adaptive binary arithmetic coding (CABAC) has been thoroughly investigated in modern video coding standards, which can effectively remove the entropy redundancy of source symbols by taking advantage of the context information during the coding process.

### 2.2. CABAC in HEVC

The CABAC engine in HEVC uses a table-based probability transition process between 64 different representative probability states. In particular, for each context variable, the two variables pStateIdx and valMps are initialized. From the 8 bit table entry initValue, the two 4 bit variables slopeIdx and offsetIdx are derived as follows:

$$\begin{matrix}slope Idx = init Value ≫ 4 \\ offset Idx = init Value \& 15\end{matrix} . \qquad ( 1 )$$

The variables m and n, used in the initialization of context variables, are derived from slopeIdx and offsetIdx as follows:

$$\begin{matrix}m = slope Idx * 5 - 45 \\ n = ( offset Idx ≪ 3 ) - 16\end{matrix} . \qquad ( 2 )$$

The two values assigned to pStateIdx and valMps for the initialization are derived from SliceQpY, which is derived in Formula (3). Given the variables m and n, the initialization is specified as follows.

| | |
|---|---|
| preCtxState = Clip3( 1, 126, ( ( m * Clip3( 0, | valMps = |

51, SliceQpY ) ) >> 4 ) + n )

| | | |
|---|---|---|
| ( preCtxState <= 63 ) ? 0 : 1 | (3). | pStateIdx = valMps ? |

( preCtxState − 64 ) : ( 63 − preCtxState )

In HEVC, the range ivlCurrRange representing the state of the coding engine is quantized to a set of 4 values prior to the calculation of the new interval range. The HEVC state transition can be implemented using a table containing all 64×4 8-bit pre-computed values to approximate the values of ivlCurrRange*pLPS(pStateIdx), where pLPS is the probability of the least probable symbol (LPS) and pStateIdx is the index of the current state. Also, a decode decision can be implemented using the pre-computed LUT. First ivlLpsRange is obtained using the LUT, i.e. ivlLpsRange=rangeTabLps[pStateIdx][qRangeIdx]. Then, ivlLpsRange is used to update ivlCurrRange and calculate the output binVal. In particular, the variable ivlCurrRange is set equal to ivlCurrRange−ivlLpsRange and the following applies:
a) If ivlOffset is greater than or equal to ivlCurrRange, the variable binVal is set equal to 1−valMps, ivlOffset is decremented by ivlCurrRange, and ivlCurrRange is set equal to ivlLpsRange.
b) Otherwise, the variable binVal is set equal to valMps.

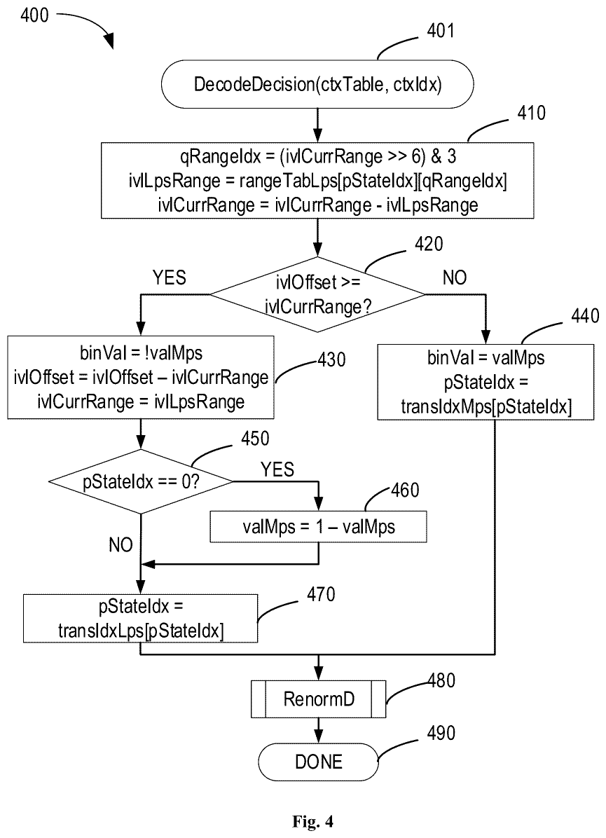

FIG. 4 illustrates a flowchart 400 for decoding a bin in HEVC. At block 401, the process DecodeDecision(ctxTable, ctxIdx) begins. At block 410, the following calculations are performed:

```
  qRangeIdx = (ivlCurrRange >> 6) & 3;
  ivlLpsRange = rangeTabLps[pStateIdx][qRangeIdx];
  ivlCurrRange = ivlCurrRange − ivlLpsRange.
At block 420, whether ivlOffset is greater than or equal to ivlCurrRange
is determined. If ivlOffset is greater than or equal to ivlCurrRange, at
block 430, the following calculations are performed:
  binVal = !valMps;
  ivlOffset = ivlOffset − ivlCurrRange;
  ivlCurrRange = ivlLpsRange.
If ivlOffset is less than ivlCurrRange, at block 440, the following
calculations are performed:
  binVal = valMps
  pStateIdx = transIdxMps[pStateIdx].
At block 450, whether pStateIdx is equal to 0 id determined. If
pStateIdx is equal to 0, at block 460, valMps = 1 − valMps. If pStateIdx
is not equal to 0, at block 470, pStateIdx = transIdxLps[pStateIdx].
At block 480, a normalization process such as RemormD is performed.
At block 490, the process DecodeDecision(ctxTable, ctxIdx) is done.
```

### 2.3. CABAC in VVC

In VVC, the probability is linearly expressed by the probability index pStateIdx. Therefore, all the calculation can be done with equations without LUT operation. To improve the accuracy of probability estimation, a multi-hypothesis probability update model is applied. The pStateIdx used in the interval subdivision in the binary arithmetic coder is a combination of two probabilities pStateIdx0 and pStateIdx1. The two probabilities are associated with each context model and are updated independently with different adaptation rates. The adaptation rates of pStateIdx0 and pStateIdx1 for each context model are pre-trained based on the statistics of the associated bins. The probability estimate pStateIdx is the average of the estimates from the two hypotheses.

As done in HEVC, VVC CABAC also has a QP dependent initialization process invoked at the beginning of each slice. Given the initial value of luma QP for the slice, the initial probability state of a context model, denoted as preCtxState, is derived as follows:

$$m = slope Idx \times 5 - 45 \qquad ( 4 )$$

$$n = ( offset Idx ≪ 3 ) + 7 \qquad ( 5 )$$

$$preCtx State = Clip 3 ( 1 , 127 , ( ( m \times ( QP - 32 ) ) ≫ 4 ) + n ) \qquad ( 6 )$$

where slopeIdx and offsetIdx are restricted to 3 bits, and total initialization values are represented by 6-bit precision. The probability state preCtxState represents the probability in the linear domain directly. Hence, preCtxState only needs proper shifting operations before input to arithmetic coding engine, and the logarithmic to linear domain mapping as well as the 256-byte table is saved.

$$p State Idx 0 = preCtx State ≪ 3 \qquad ( 7 )$$

$$p State Idx 1 = preCtx State ≪ 7. \qquad ( 8 )$$

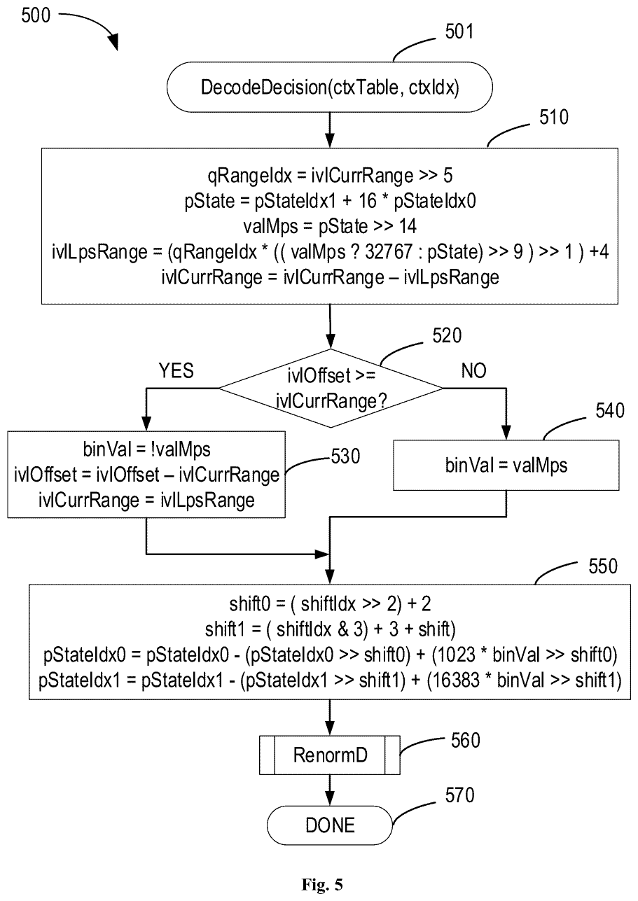

FIG. 5 illustrates a flowchart 500 for decoding a bin in VVC. At block 501, the process DecodeDecision(ctxTable, ctxIdx) begins. At block 510, the following calculations are performed.

Once pStateIdx0 and pStateIdx1 are derived, the value of the variable ivlLpsRange is derived as follows. Given the current value of ivlCurrRange, the variable qRangeIdx is derived as follows:

| | |
|---|---|
| qRangeIdx = ivlCurrRange >> 5 | (9). |

Given qRangeIdx, pStateIdx0 and pStateIdx1 associated with ctxTable
and ctxIdx, valMps and ivlLpsRange are derived as follows:
pState = pStateIdx1 + 16 * pStateIdx0

| | |
|---|---|
| valMps = pState >> 14 | (10) |

```
  ivlLpsRange = ( qRangeIdx * ( ( valMps ? 32767 − pState : pState ) >>
  9 ) >> 1 ) + 4.
```

Then the variable ivlCurrRange is set equal to ivlCurrRange−ivlLpsRange and at block 520, whether ivlOffset is greater than or equal to ivlCurrRange is determined and the following applies:
1. If ivlOffset is greater than or equal to ivlCurrRange, at block 530, the variable binVal is set equal to 1−valMps, ivlOffset is decremented by ivlCurrRange, and ivlCurrRange is set equal to ivlLpsRange. For example, binVal=!valMps; ivlOffset=ivlOffset−ivlCurrRange; and ivlCurrRange=ivlLpsRange.
2. Otherwise, if ivlOffset is less than ivlCurrRange, at block 540, the variable binVal is set equal to valMps.

At block 550, the multi-hypothesis probability model is then updated independently with two different adaptation rates shift0 and shift1, which are derived based on the shiftIdx value in ctxTable and ctxIdx.

$$\begin{matrix}shift 0 = ( shift Idx ≫ 2 ) + 2 \\ shift 1 = ( shift Idx \& 3 ) + 3 + shift 0\end{matrix} . \qquad ( 11 )$$

Based on the decoded value binVal, the updated variables pStateIdx0 and pStateIdx1 associated with ctxTable and ctxIdx are derived as follows:

pStateIdx0=pStateIdx0−(pStateIdx0>>shift0)+(1023*binVal>>shift0)

pStateIdx1=pStateIdx1−(pStateIdx1>>shift1)+(16383*binVal>>shift1) (12).

At block 560, a normalization process such as RemormD is performed. At block 570, the process DecodeDecision(ctxTable, ctxIdx) is done.

### 2.4. CABAC Improvements in Enhanced Compression Model (ECM)

In ECM, adaptive weights are assigned to multi-hypothesis-based probability model. In particular, two separate probability models p₀ and p₁ are maintained for each context and updated according to their own adaptation rates. Different from VVC that uses simple average to obtain resulting context state, multiple weights are introduced as illustrated below:

$$p = ( ( 32 - ω ) \cdot {p}_{0} + ω \cdot {p}_{1} ) ≫ 5 \qquad ( 13 )$$

where ω is the weight selected from a pre-defined set ω∈{0, 6, 11, 16, 21, 26, 32}.

In ECM, Temporal inheritance-based context initialization is applied to inter slices. The probabilities and the weights of the context models of the inter slice (i.e., B- or P-slice types) that contains the last CTU in the previously coded picture is stored. The stored states will be used to initialize the context models in the next inter slice that has the same slice type, the QP value, and temporal layer ID.

### 2.5. Adaptive Parameter Sets (APS)

VVC introduce Adaptation parameter sets (APSs) to convey picture- and/or slice-level information that may be shared by multiple slices of a picture, and/or by slices of different pictures, but could change frequently from picture-to-picture and for which the total number of variants could be very high thus not suitable for inclusion into the PPS. Three types of parameters are included in APSs: adaptive loop filter (ALF) parameters, luma mapping with chroma scaling (LMCS) parameters, and quantization scaling list parameters. Depending on the type of data they carry, APSs can be carried in two distinct NAL (network abstraction layer) unit types, either preceding or succeeding the associated slices as a prefix or suffix. Using suffix NAL units could be helpful for ALF parameters, since a typical way for an encoder to operate, especially in low-delay use cases, would be to use the statistics of the current picture to generate the ALF parameters to apply to subsequent pictures in decoding order.

### 3. Problem

In ECM, temporal inheritance-based context initialization is adopted to facilitate better CABAC context modelling, where the context states of the to-be-coded frame can be inherited from that of an already coded frame with the same slice type, and/or the QP value, and/or temporal layer ID. To this end, a context buffer is managed in both encoder and decoder to store and update the context model information that can be inherited for the subsequent frames. However, this inheritance strategy raises a critical issue in terms of frame/slice dependency, as the to-be-coded frame can only be decoded when the frame refereed for contexts is decoded, which however may not even within the reference frame list of the to-be-coded frame.

### 4. Detailed Solutions

In this disclosure, it is proposed to optimize temporal inheritance-based context initialization by signalling the information (or parameters) of context models in SPS/APS/PPS/picture header/slice header/CTU line/CTU. Instead of managing the context buffer based on the encoded/decoded frame/slice information, the inherited context models information and the corresponding frame/slice are separated by signalling the information context models in SPS/APS/PPS/picture header/slice header/CTU line/CTU, such that the decoding of the to-be-coded frame will have no dependency on the video coding layer (VCL) network abstraction layer (NAL) of a non-reference frame.

The detailed embodiments below should be considered as examples to explain general concepts. These embodiments should not be interpreted in a narrow way. Furthermore, these embodiments can be combined in any manner. Combination between this patent application and others are also applicable.

In this disclosure, the information of a context model may include at least one parameter or values, which may be used to initialize at least one context model.
1. It is proposed that specific information of at least one context model may be signalled in a video unit such as in the SPS/APS/PPS/picture header/slice header/CTU line/CTU.
   a) In one example, when the last CTU in arbitrary B/P frames/slices finishes is encoded, the information of at least one context model may be encoded in the video unit.
      i. In one example, alternatively, when the central CTU or the CTU in arbitrary position is encoded, the information of at least one context model may be encoded in the video unit.
   b) In one example, a decoder may initialize the context of at least one model based on information of the context model signaled in the video unit.
   c) In one example, the information of at least one context model may be signalled in APS.
      i. In one example, the information can be signalled (or encoded) in either prefix APS or suffix APS.
   d) In one example, a first syntax element (SE) may be signaled to indicate the type of the information carried in the video unit (e.g., APS).
      i. In one example, the first index may indicate whether the specific information is carried in the video coding.
      ii. For example, the specific information is signaled only if it is indicated that the specific information is carried.
   e) In one example, the specific information may be signalled in the extension part of APS.
      i. In one example, the SE which indicates whether APS extension exists is signaled. Only if this SE indicated APS extension data exists, the specific information may be signaled in the APS extension data.
   f) In one example, the specific information may be signalled in a first video unit (such as PPS/picture header/slice header/APS/etc.).
      i. In one example, a SE (termed as A) indicating whether the information (or parameters) of context models is signalled in the PPS is signaled, if this SE indicates the information is signalled in PPS, then the information will be signaled in PPS.
         1) In one example, whether SE A is signaled in the first video unit may be dependent on SE B in a second video unit, such as SPS/VPS/etc.
         a) In one example, SE B may indicate whether a coding tool which needs to signal the information is enabled.
         b) In one example, SE B may indicate whether the information can be signalled in the first video unit.
         2) In one example, whether SE A is signaled in the first video unit may be dependent on multiple SEs B₁ . . . Bₙ which may be signaled in different video units.
         a) In one example, SE in B₁ . . . Bₙ may indicate whether a coding tool which needs to signal the information is enabled, or whether the information can be signalled in the first video unit.
         b) In one example, multiple SEs are combined to mutually determine whether the information can be signalled in the first video unit.
   g) In one example, whether to signal the specific information of at least one context model may be controlled by one or multiple syntax.
      i. In one example, a syntax in SPS/VPS/PPS/picture header/slice header is used to indicate if it needs to signal the specific information.
      ii. In one example, the specific information can be signalled in PPS, picture header, slice header or any other high level syntax module.
         1) In one example, whether the specific information is signalled in PPS is dependent on one or multiple SPS/NPS/PPS level syntax.
         2) In one example, whether the specific information is signalled in picture header is dependent on one or multiple SPS/NPS/PPS level syntax.
         3) In one example, whether the specific information is signalled in slice header is dependent on one or multiple SPS/NPS/PPS level syntax.
2. In one example, the specific information of at least one context model to be signalled (or encoded) may include probability parameters, updating speed (i.e., window size), indicators of initialized probability values and/or any other parameters that are related to context models.
3. It is proposed to manage a context parameters buffer in encoder and/or decoder. Let M (M>0) denote the number of context models under consideration, then:
   a) In one example, K (K>=0) sets of context information or parameters (here a set of information/parameters includes all or partial parameters associated with a specific context model) may be stored for N (N<=M) different contexts, where one or multiple set(s) of context model parameters are stored for certain context models.
      i. In one example, alternatively, no information/parameter of context model is stored for at least one context model.
   b) In one example, for different QP, or/and slice type, or/and temporal layer, different sets of context parameters are stored in the buffer.
      i. In one example, when certain frames/slices finish encoding process, all or partial of the context model parameters are signalled. At the decoder, these context model parameters are decoded and used to update the context buffer, which is then used to initialize the context states for the subsequent frames.
         1) In one example, only one set of context model parameters is stored for certain QP, or/and slice type, or/and temporal layer.
         2) In one example, alternatively, multiple sets of context model parameters are store for certain QP, or/and slice type, or/and temporal layer.
   c) In one example, the context buffer is built to provide reference context for predictive context coding.
4. In one example, the specific information of at least one context model which may be used to initialize the context model may be signalled for all or partial B/P frames.
   a) In one example, only the information for partial B/P frames are signalled.
      i. In one example, whether the information of the current slice/frame are signalled may be dependent on the QP value.
      ii. In one example, whether the information of the current slice/frame are signalled may be dependent on the slice type.
      iii. In one example, whether the information of the current slice/frame are signalled may be dependent on the temporal layer index.
   b) In one example, the context models are signalled in a fixed or adaptively determined POC interval.
5. In one example, for a frame or slice that needs to signal the specific information of at least one context model which may be used to initialize the context, all or partial context model information/parameters in this frame may be signalled. Let M (M>0) denote the number of different context models used in coding process, then:
   a) In one example, K (M>=K>=0) context states are signalled.
      i. In one example, M context models are sorted based on certain metrics, and the information/parameters of top-K contexts are signalled.
         1) In one example, K may be a constant for all the frames/slices, or may be different from one frame/slice to another.
      ii. In one example, alternatively, only the information/parameters of certain contexts that satisfy certain conditions are signalled.
         1) In one example, specifically, the number of the contexts that need to signal model parameters may be a constant, or be adaptively determined in each frame/slice.
      iii. In one example, only the information/parameters of some pre-defined contexts are signalled.
      iv. In one example, for those contexts do not signal model parameters, CABAC context initialization table is used to initialize the context state.
   b) In one example, the context parameters for all the context models are signalled.
6. It is proposed to use predictive coding method to code the specific information of at least one context model which may be used to initialize the context model.
   a) In one example, the coding procedure of a context model that need to signal model parameters may depend on the parameters of a reference model.
   b) In one example, for a context model that need to signal model parameters, a reference context model is fetched and the difference (or residual) between the parameters of the reference model and current model is signalled.
      i. In one example, the reference model may be derived based on the CABAC initialization table.
      ii. In one example, the reference model may be derived based on the stored context information/parameters in the context buffer.
         1) In one example, the context model information/parameters for the same QP, or slice type, or temporal layer is used as reference context.
         2) In one example, alternatively, arbitrary model information/parameter in the context buffer can be used as reference.
         a) In one example, specifically, a context index, and/or a QP index, and/or a slice type index, and/or a temporal layer index may be used to identify the reference context.
   c) The difference (or residual) of the context parameters may be coded with truncated Rice (TR) code, the truncated binary (TB) code, the k-th order Exp-Golomb (EGk) code or the fixed-length (FL) code.
   d) The difference (or residual) of the context parameters may be coded by CABAC.
   e) The difference (or residual) of the context parameters may be encoded after quantization, and decoder need to perform de-quantization to derive the different signal.
7. In one example, for a context model used in a first frame or slice. It may be initialized with the initialization information of the context model which may be signaled in a second frame or slice.
   a) In one example, the second frame/slice must be or belong to a reference frame of the first frame/slice.
   b) In one example, it may be signaled to indicate the initialization information of the context model is associated with which reference frame.
      i. For example, the reference list and/or reference index may be signaled to indicate the reference frame.

### 5. Embodiments

In one example, when all or partial B/P frames/slices finish encoding process, the context model parameters of the last CTU is encoded and signalled in APS, and a syntax is signalled in picture header/slice header/PPS/SPS to indicate whether context parameters for the current frame/slice is signalled. And these context model parameters are also stored in a local buffer. To efficiently encode the context parameters, a reference context is firstly fetched from the context buffer, where the context model parameters for the same QP, or slice type, or temporal layer is used as reference context model by default. Alternatively, arbitrary model parameters in the context buffer can be used as reference. In later case, a reference index is signalled to identify the reference context. Afterwards, the different (or residual) of context parameters may firstly be quantitated before being coded with truncated Rice (TR) code/truncated binary (TB) code/k-th order Exp-Golomb (EGk) code/fixed-length (FL) code.

At the decoder side, when a frame/slice with the same QP/slice type/temporal layer index is being decoded, a picture header/slice header/PPS/SPS level syntax is firstly parsed to indicate if context parameters are signalled in APS. If yes, corresponding parameters are decoded by firstly identifying the APS that conveys context parameters, and the decoded context parameters are then used to initialize the CABAC context. The difference (or residual) context parameters may be decoded with truncated Rice (TR) code/truncated binary (TB) code/k-th order Exp-Golomb (EGk) code/fixed-length (FL) code, and then be de-quantitated. The restoration of a context model parameter is realized by adding the decoded context parameter difference (or residual) to a reference context parameter, which by default belongs to the context with the same QP/slice type/temporal layer index in the context buffer, or an arbitrary context model specified by a reference index. These decoded and restored context models parameters are used to initialize the context in the current frame/slice. Once the context models parameters of the current frame/slice is decoded and restored, they are then used to update the context buffer, which provides reference context to facilitate more efficient context model parameters signalling.

An example of the syntax in tabular form that signals the specific information of at least one context model in APS is provided as below.

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| else if( aps_params_type = = CABAC_APS ) | |
| CABAC_model_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

In particular, aps_params_type indicates the APS type, which may be adaptive loop filter (ALF) parameters (ALF_APS), luma mapping with chroma scaling (LMCS) parameters (LMCS_APS), and quantization scaling list parameters (SCALING_APS) or CABAC context model parameters (CABAC_APS). If aps_params_type is parsed and indicates context model parameters are signalled, then CABAC_model_data( ) will be parsed, which contains the specific information of contexts to be used for the current or subsequent frames/slices.

The embodiments of the present disclosure are related to context model determination or initiation. As used herein, the term “block” may represent a coding tree block (CTB), a coding tree unit (CTU), a coding block (CB), a coding unit (CU), a prediction unit (PU), a transform unit (TU), a prediction block (PB), a transform block (TB), or a video processing unit comprising a plurality of samples or pixels. A block may be rectangular or non-rectangular.

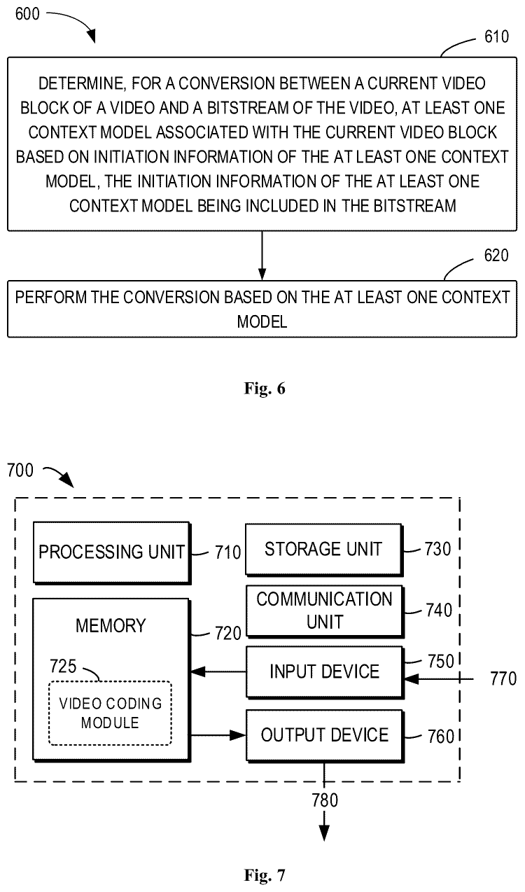

FIG. 6 illustrates a flowchart of a method 600 for video processing in accordance with embodiments of the present disclosure. The method 600 is implemented for a conversion between a current video block of a video and a bitstream of the video.

At block 610, at least one context model associated with the current video block is determined based on initiation information of the at least one context model. The initiation information of the at least one context model is included in the bitstream. As used herein, the term “initiation information of the at least one context model” may also be referred to as “specific information of the at least one context model”. In an example, the at least one context model is initiated based on the initiation information. For example, the initiation information of a context model may include at least one parameter or values, which may be used to initialize at least one context model.

At block 620, the conversion is performed based on the at least one context model. In some embodiments, the conversion between the current video block and the bitstream may include encoding the current video block into the bitstream. Alternatively, or in addition, the conversion may include decoding the current video block from the bitstream.

The method 600 enables initiating the at least one context model based on initiation information in the bitstream. In this way, the coding effectiveness and coding efficiency can be advantageously improved.

In some embodiments, the initiation information of the at least one context model comprises at least one of: a probability parameter, an updating speed of the probability parameter, an indicator of an initialized value of the probability parameter, or a further parameter associated with the at least one context model. For example, the updating speed may be a window size.

In some embodiments, the initiation information of the at least one context model is included in a first video unit in the bitstream. By way of example, the first video unit comprises at least one of: a sequence parameter set (SPS), an adaptation parameter set (APS), a picture parameter set (PPS), a picture header, a slice header, a coding tree unit (CTU), or a CTU line. For example, the initiation information of at least one context model may be signalled in a video unit such as in the SPS/APS/PPS/picture header/slice header/CTU line/CTU.

In some embodiments, the first video unit comprises at least one of: a prefix adaptation parameter set (APS), or a suffix APS. In one example, the information may be signalled (or encoded) in either prefix APS or suffix APS.

In some embodiments, a first syntax element is included in the bitstream, the first syntax element indicating a type of information included in the video unit. In one example, a first syntax element (SE) may be signaled to indicate the type of the information carried in the video unit (e.g. APS).

In one example, the syntax element aps_params_type indicates the APS type, which may be adaptive loop filter (ALF) parameters (ALF_APS), luma mapping with chroma scaling (LMCS) parameters (LMCS_APS), and quantization scaling list parameters (SCALING_APS) or CABAC context model parameters (CABAC_APS). If aps_params_type is parsed and indicates context model parameters are signalled, then CABAC_model_data( ) may be parsed, which contains the specific information of contexts to be used for the current or subsequent frames/slices.

In some embodiments, the first syntax element further indicates whether the initiation information of the at least one context model is included in the first video unit. For example, the first syntax element may indicate whether the specific information is carried in the video coding.

In some embodiments, if the first syntax element indicates the initiation information of the at least one context model, the initiation information is included in the first video unit.

In some embodiments, at least one second syntax element indicating whether the first syntax element is included in the first video unit is included in at least one second video unit in the bitstream.

In some embodiments, the at least one second syntax element comprises a single second syntax element in a single second video unit.

In some embodiments, the first video unit comprises a picture parameter set (PPS), and the single second video unit comprises one of: a sequence parameter set (SPS), or a video parameter set (VPS).

In some embodiments, the single second syntax element indicates whether a coding tool is enabled, the initiation information of the at least one context model being included in the first video unit by the coding tool.

In some embodiments, the single second syntax element indicates whether the initiation information of the at least one context model is included in the first video unit.

In some embodiments, the at least one at least one second syntax element comprises a plurality of second syntax elements in a plurality of second video units, the plurality of second video units being different video units.

In some embodiments, one of the plurality of second syntax elements indicates whether a coding tool is enabled, the initiation information of the at least one context model being included in the first video unit by the coding tool, and another one of the plurality of second syntax elements indicates whether the initiation information of the at least one context model is included in the first video unit.

In some embodiments, a combination of the plurality of second syntax elements indicates whether the initiation information of the at least one context model is included in the first video unit. That is, multiple SEs are combined to mutually determine whether the information may be signalled in the first video unit.

In some embodiments, the first video unit comprises an extension part of an adaptation parameter set (APS).

In some embodiments, a first syntax element indicates whether the extension part of the APS exists is included in the bitstream. In some embodiments, if the first syntax element indicates that the extension part exists, the initiation information of the at least one context model is included in the extension part.

In some embodiments, if a coding tree unit (CTU) in a frame or a slice is coded, the initiation information of the at least one context model is included in the bitstream, the frame comprising a B frame or a P frame, the slice comprising a B slice or a B frame.

In some embodiments, the CTU comprises at least one of: a last CTU in the frame or slice, a central CTU in the frame or slice, or a CTU in a predefined position in the frame or slice. For example, when the last CTU in arbitrary B/P frames/slices finishes is encoded, the information of at least one context model may be encoded in the first video unit. For another example, when the central CTU or the CTU in arbitrary position is encoded, the information of at least one context model may be encoded in the first video unit.

In some embodiments, determining the at least one context model comprises: initiating at least one context of the at least one context model based on the initiation information. For example, a decoder may initialize the context of at least one model based on information of the context model signaled in the first video unit.

In some embodiments, the method 600 further comprises: determining whether to include the initiation information of the at least one context model in the bitstream based on at least one syntax element in the bitstream.

In some embodiments, the at least one syntax element is in at least one video unit, the at least one video unit comprising at least one of: a sequence parameter set (SPS), a video parameter set (VPS), a picture parameter set (PPS), a picture header, or slice header.

In some embodiments, the at least one syntax element indicates whether the at least one video unit comprises the initiation information of the at least one context model.

In some embodiments, the initiation information of the at least one context model is included in a high-level syntax module, the high-level syntax module comprising at least one of: a picture parameter set (PPS), a picture header, or slice header.

In some embodiments, the at least one syntax element in at least one of a sequence parameter set (SPS), a video parameter set (VPS) or a picture parameter set (PPS) indicates whether the initiation information of the at least one context model is included in the high-level syntax module.

In some embodiments, the method 600 further comprises: storing context information of the at least one context model in a context parameter buffer.

In some embodiments, the context parameter buffer is in at least one of: an encoder associated with an encoding conversion from the current video block into the bitstream, or a decoder associated with a decoding conversion from the bitstream into the current video block. That is, the context parameter buffer may be managed in encoder and/or decode.

In some embodiments, the context information comprises a plurality of sets of context parameters associated with the at least one context model, a set of context parameters comprising a plurality of contexts associated with a context model of the at least one context model. In some embodiments, the number of the at least one context model is less than or equal to the number of the plurality of sets of the context parameters. In other words, K (K>=0) sets of context information or parameters (here a set of information/parameters includes all or partial parameters associated with a specific context model) may be stored for N (N<=M) different contexts, where one or multiple set(s) of context model parameters are stored for certain context models.

In some embodiments, the plurality of sets of context parameters comprises a first set of context parameter associated with a first quantization parameter (QP) and a second set of context parameter associated with a second QP. For example, example, for different QP, or/and slice type, or/and temporal layer, different sets of context parameters are stored in the buffer.

In some embodiments, the plurality of sets of context parameters comprises a third set of context parameter associated with a first slice type and a fourth set of context parameter associated with a second slice type.

In some embodiments, the plurality of sets of context parameters comprises a fifth set of context parameter associated with a first temporal layer and a sixth set of context parameter associated with a second temporal layer.

In some embodiments, a single set of context parameters of the plurality of sets of context parameters is associated with at least one of: a first quantization parameter (QP), a first slice type, or a first temporal layer.

In some embodiments, more than one of the plurality of sets of context parameters is associated with at least one of: a first quantization parameter (QP), a first slice type, or a first temporal layer.

In some embodiments, if a coding process of a current frame or a current slice is completed, the context information of at least a partial of context parameters of the at least one context model is included in the bitstream.

In some embodiments, the method 600 further comprises: coding the context information of the at least partial of context parameters; and updating the context parameter buffer based on the context information.

In some embodiments, the context information is used for initializing a context state of a subsequent frame subsequent to the current frame. For example, when certain frames/slices finish encoding process, all or partial of the context model parameters are signalled. At the decoder, these context model parameters are decoded and used to update the context buffer, which is then used to initialize the context states for the subsequent frames.

In some embodiments, no context information of a context model of the at least one context model is stored in the context parameter buffer. For example, no information/parameter of context model is stored for at least one context model.

In some embodiments, the context parameter buffer comprises a reference context for a predictive context coding. For example, the context buffer is built to provide reference context for predictive context coding.

In some embodiments, the initiation information of the at least one context model is included for at least a partial of B frames, or at least a partial of P frames. For example, the specific information of at least one context model which may be used to initialize the context model may be signalled for all or partial B/P frames.

In some embodiments, whether the initiation information of the at least one context model associated with a current slice or a current frame is included in the bitstream is based on at least one of: a quantization parameter (QP) value, a slice type, or a temporal layer index.

In some embodiments, the initiation information of the at least one context model is included in the bitstream based on a picture order count (POC) interval.

In some embodiments, the POC interval is predefined or determined during the conversion. That is, the context models are signalled in a fixed or adaptively determined POC interval.

In some embodiments, if the initiation information of the at least one context model associated with a frame or a slice is included in the bitstream, at least a partial of context information in the frame or slice is included in the bitstream.

In some embodiments, the at least one context model comprises a first number of context models, a second number of context states is included in the bitstream, the second number being less than or equal to the first number.

In some embodiments, the method 600 further comprises: sorting the first number of context models based on a metric; determining the second number of context models from the first number of context models based on the sorting; and including the second number of context states associated with the second number of context models in the bitstream. For example, M context models are sorted based on certain metrics, and the information/parameters of top-K contexts are signalled.

In some embodiments, the second number is the same or different for a plurality of frames or a plurality of slices. For example, K may be a constant for all the frames/slices, or may be different from one frame/slice to another.

In some embodiments, if a context state of a context model of the at least one context model satisfies a condition, the context state is included in the bitstream. For example, only the information/parameters of certain contexts that satisfy certain conditions are signalled.

In some embodiments, the second number is a predefined value, or is determined for a frame or a slice. For example, the number of the contexts that need to signal model parameters may be a constant, or be adaptively determined in each frame/slice.

In some embodiments, the second number of context states comprises a plurality of predefined contexts. For example, only the information/parameters of some pre-defined contexts are signalled.

In some embodiments, if context information associated with a first context model is not included in the bitstream, a context state of the first context model is initialized based on a context based adaptive binary arithmetic coding (CABAC) context initialization table. For example, for those contexts do not signal model parameters, CABAC context initialization table is used to initialize the context state.

In some embodiments, context information associated with the at least one context model is included in the bitstream.

In some embodiments, the method 600 further comprises: determining the initiation information of the at least one context model by using a predictive coding.

In some embodiments, a coding process associated with the current video block is based on a parameter of a reference model, context information of the at least one context model is included in the bitstream during the coding process. For example, the coding procedure of a context model that need to signal model parameters may depend on the parameters of a reference model.

In some embodiments, a difference between a first value of a context parameter of a reference model and a second value of the context parameter of a current context model of the at least one context model is included in the bitstream. As used herein, the term “difference” may be also referred to as a “residual”. For example, for a context model that need to signal model parameters, a reference context model is fetched and the difference (or residual) between the parameters of the reference model and current model is signalled.

In some embodiments, the method 600 further comprises: determining the reference model based on a context based adaptive binary arithmetic coding (CABAC) context initialization table.

In some embodiments, the difference is coded by at least one of: a truncated rice (TR) coding tool, a truncated binary (TB) coding tool, a k-th order exponential-Golomb (EGk) coding tool, or a fixed-length (FL) coding tool.

In some embodiments, the difference is coded by a context based adaptive binary arithmetic coding (CABAC). For example, the reference model may be derived based on the CABAC initialization table.

In some embodiments, the method 600 further comprises: updating the difference by applying a quantization or de-quantization process to the difference.

In some embodiments, the method 600 further comprises: determining the reference model based on context information stored in a context parameter buffer.

In some embodiments, the method 600 further comprises: determining the reference model from the context parameter buffer based on at least one of: a context index, a quantization parameter (QP) index, a slice type index, or a temporal layer index.

In some embodiments, the reference model comprises reference context information associated with at least one of: a quantization parameter (QP) of the at least one context model, a slice type of the at least one context model, or a temporal layer of the at least one context model.

In some embodiments, the initiation information of the at least one context model is included in a first frame or slice, and the at least one context model is used in a second frame or slice. In some embodiments, the first frame or slice is a reference frame of the second frame or slice.

In some embodiments, an association between the reference frame and the information of the at least one context model is included in the bitstream. For example, it may be signaled to indicate the initialization information of the context model is associated with which reference frame.

In some embodiments, at least one of a reference list or a reference index associated with the reference frame is included in the bitstream. For example, the reference list and/or reference index may be signaled to indicate the reference frame.

According to further embodiments of the present disclosure, a non-transitory computer-readable recording medium is provided. The non-transitory computer-readable recording medium stores a bitstream of a video which is generated by a method performed by an apparatus for video processing. In the method, at least one context model associated with a current video block of the video is determined based on initiation information of the at least one context model. The initiation information of the at least one context model is included in the bitstream. The bitstream is generated based on the at least one context model.

According to still further embodiments of the present disclosure, a method for storing bitstream of a video is provided. In the method, at least one context model associated with a current video block of the video is determined based on initiation information of the at least one context model. The initiation information of the at least one context model is included in the bitstream. The bitstream is generated based on the at least one context model. The bitstream is stored in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, at least one context model associated with the current video block based on initiation information of the at least one context model, the initiation information of the at least one context model being included in the bitstream; and performing the conversion based on the at least one context model.

Clause 2. The method of clause 1, wherein the initiation information of the at least one context model comprises at least one of: a probability parameter, an updating speed of the probability parameter, an indicator of an initialized value of the probability parameter, or a further parameter associated with the at least one context model.

Clause 3. The method of clause 1 or clause 2, wherein the initiation information of the at least one context model is included in a first video unit in the bitstream.

Clause 4. The method of clause 3, wherein the first video unit comprises at least one of: a sequence parameter set (SPS), an adaptation parameter set (APS), a picture parameter set (PPS), a picture header, a slice header, a coding tree unit (CTU), or a CTU line.

Clause 5. The method of clause 3 or clause 4, wherein the first video unit comprises at least one of: a prefix adaptation parameter set (APS), or a suffix APS.

Clause 6. The method of any of clauses 3-5, wherein a first syntax element is included in the bitstream, the first syntax element indicating a type of information included in the video unit.

Clause 7. The method of clause 6, wherein the first syntax element further indicates whether the initiation information of the at least one context model is included in the first video unit.

Clause 8. The method of clause 6 or clause 7, wherein if the first syntax element indicates the initiation information of the at least one context model, the initiation information is included in the first video unit.

Clause 9. The method of any of clauses 6-8, wherein at least one second syntax element indicating whether the first syntax element is included in the first video unit is included in at least one second video unit in the bitstream.

Clause 10. The method of clause 9, wherein the at least one second syntax element comprises a single second syntax element in a single second video unit.

Clause 11. The method of clause 10, wherein the first video unit comprises a picture parameter set (PPS), and the single second video unit comprises one of: a sequence parameter set (SPS), or a video parameter set (VPS).

Clause 12. The method of clause 10 or clause 11, wherein the single second syntax element indicates whether a coding tool is enabled, the initiation information of the at least one context model being included in the first video unit by the coding tool.

Clause 13. The method of clause 10 or clause 11, wherein the single second syntax element indicates whether the initiation information of the at least one context model is included in the first video unit.

Clause 14. The method of clause 9, wherein the at least one at least one second syntax element comprises a plurality of second syntax elements in a plurality of second video units, the plurality of second video units being different video units.

Clause 15. The method of clause 14, wherein one of the plurality of second syntax elements indicates whether a coding tool is enabled, the initiation information of the at least one context model being included in the first video unit by the coding tool, and another one of the plurality of second syntax elements indicates whether the initiation information of the at least one context model is included in the first video unit.

Clause 16. The method of clause 14, wherein a combination of the plurality of second syntax elements indicates whether the initiation information of the at least one context model is included in the first video unit.

Clause 17. The method of any of clauses 3-16, wherein the first video unit comprises an extension part of an adaptation parameter set (APS).

Clause 18. The method of clause 17, wherein a first syntax element indicates whether the extension part of the APS exists is included in the bitstream.

Clause 19. The method of clause 18, wherein if the first syntax element indicates that the extension part exists, the initiation information of the at least one context model is included in the extension part.

Clause 20. The method of any of clauses 1-19, wherein if a coding tree unit (CTU) in a frame or a slice is coded, the initiation information of the at least one context model is included in the bitstream, the frame comprising a B frame or a P frame, the slice comprising a B slice or a B frame.

Clause 21. The method of clause 20, wherein the CTU comprises at least one of: a last CTU in the frame or slice, a central CTU in the frame or slice, or a CTU in a predefined position in the frame or slice.

Clause 22. The method of any of clauses 1-21, wherein determining the at least one context model comprises: initiating at least one context of the at least one context model based on the initiation information.

Clause 23. The method of any of clauses 1-22, further comprising: determining whether to include the initiation information of the at least one context model in the bitstream based on at least one syntax element in the bitstream.

Clause 24. The method of clause 23, wherein the at least one syntax element is in at least one video unit, the at least one video unit comprising at least one of: a sequence parameter set (SPS), a video parameter set (VPS), a picture parameter set (PPS), a picture header, or slice header.

Clause 25. The method of clause 24, wherein the at least one syntax element indicates whether the at least one video unit comprises the initiation information of the at least one context model.

Clause 26. The method of clause 23, wherein the initiation information of the at least one context model is included in a high-level syntax module, the high-level syntax module comprising at least one of: a picture parameter set (PPS), a picture header, or slice header.

Clause 27. The method of clause 26, wherein the at least one syntax element in at least one of a sequence parameter set (SPS), a video parameter set (VPS) or a picture parameter set (PPS) indicates whether the initiation information of the at least one context model is included in the high-level syntax module.

Clause 28. The method of any of clauses 1-27, further comprising: storing context information of the at least one context model in a context parameter buffer.

Clause 29. The method of clause 28, wherein the context parameter buffer is in at least one of: an encoder associated with an encoding conversion from the current video block into the bitstream, or a decoder associated with a decoding conversion from the bitstream into the current video block.

Clause 30. The method of clause 28 or clause 29, wherein the context information comprises a plurality of sets of context parameters associated with the at least one context model, a set of context parameters comprising a plurality of contexts associated with a context model of the at least one context model.

Clause 31. The method of clause 30, wherein the number of the at least one context model is less than or equal to the number of the plurality of sets of the context parameters.

Clause 32. The method of clause 30 or clause 31, wherein the plurality of sets of context parameters comprises a first set of context parameter associated with a first quantization parameter (QP) and a second set of context parameter associated with a second QP.

Clause 33. The method of any of clauses 30-32, wherein the plurality of sets of context parameters comprises a third set of context parameter associated with a first slice type and a fourth set of context parameter associated with a second slice type.

Clause 34. The method of any of clauses 30-33, wherein the plurality of sets of context parameters comprises a fifth set of context parameter associated with a first temporal layer and a sixth set of context parameter associated with a second temporal layer.

Clause 35. The method of any of clauses 30-34, wherein a single set of context parameters of the plurality of sets of context parameters is associated with at least one of: a first quantization parameter (QP), a first slice type, or a first temporal layer.

Clause 36. The method of any of clauses 30-34, wherein more than one of the plurality of sets of context parameters is associated with at least one of: a first quantization parameter (QP), a first slice type, or a first temporal layer.

Clause 37. The method of any of clauses 28-36, wherein if a coding process of a current frame or a current slice is completed, the context information of at least a partial of context parameters of the at least one context model is included in the bitstream.

Clause 38. The method of clause 37, further comprising: coding the context information of the at least partial of context parameters; and updating the context parameter buffer based on the context information.

Clause 39. The method of clause 37 or clause 38, wherein the context information is used for initializing a context state of a subsequent frame subsequent to the current frame.

Clause 40. The method of clause 28, wherein no context information of a context model of the at least one context model is stored in the context parameter buffer.

Clause 41. The method of any of clauses 28-40, wherein the context parameter buffer comprises a reference context for a predictive context coding.

Clause 42. The method of any of clauses 1-40, wherein the initiation information of the at least one context model is included for at least a partial of B frames, or at least a partial of P frames.

Clause 43. The method of clause 42, wherein whether the initiation information of the at least one context model associated with a current slice or a current frame is included in the bitstream is based on at least one of: a quantization parameter (QP) value, a slice type, or a temporal layer index.

Clause 44. The method of any of clauses 1-43, wherein the initiation information of the at least one context model is included in the bitstream based on a picture order count (POC) interval.

Clause 45. The method of clause 44, wherein the POC interval is predefined or determined during the conversion.

Clause 46. The method of any of clauses 1-45, wherein if the initiation information of the at least one context model associated with a frame or a slice is included in the bitstream, at least a partial of context information in the frame or slice is included in the bitstream.

Clause 47. The method of clause 46, wherein the at least one context model comprises a first number of context models, a second number of context states is included in the bitstream, the second number being less than or equal to the first number.

Clause 48. The method of clause 47, further comprising: sorting the first number of context models based on a metric; determining the second number of context models from the first number of context models based on the sorting; and including the second number of context states associated with the second number of context models in the bitstream.

Clause 49. The method of clause 47 or clause 48, wherein the second number is the same or different for a plurality of frames or a plurality of slices.

Clause 50. The method of any of clauses 47-49, wherein if a context state of a context model of the at least one context model satisfies a condition, the context state is included in the bitstream.

Clause 51. The method of any of clauses 47-50, wherein the second number is a predefined value, or is determined for a frame or a slice.

Clause 52. The method of any of clauses 47-51, wherein the second number of context states comprises a plurality of predefined contexts.

Clause 53. The method of any of clauses 1-52, wherein if context information associated with a first context model is not included in the bitstream, a context state of the first context model is initialized based on a context based adaptive binary arithmetic coding (CABAC) context initialization table.

Clause 54. The method of any of clauses 1-53, wherein context information associated with the at least one context model is included in the bitstream.

Clause 55. The method of any of clauses 1-54, further comprising: determining the initiation information of the at least one context model by using a predictive coding.

Clause 56. The method of any of clauses 1-55, wherein a coding process associated with the current video block is based on a parameter of a reference model, context information of the at least one context model is included in the bitstream during the coding process.

Clause 57. The method of any of clauses 1-56, wherein a difference between a first value of a context parameter of a reference model and a second value of the context parameter of a current context model of the at least one context model is included in the bitstream.

Clause 58. The method of clause 56 or clause 57, further comprising: determining the reference model based on a context based adaptive binary arithmetic coding (CABAC) context initialization table.

Clause 59. The method of clause 57, wherein the difference is coded by at least one of: a truncated rice (TR) coding tool, a truncated binary (TB) coding tool, a k-th order exponential-Golomb (EGk) coding tool, or a fixed-length (FL) coding tool.

Clause 60. The method of clause 57, wherein the difference is coded by a context based adaptive binary arithmetic coding (CABAC).

Clause 61. The method of any of clauses 57-60, further comprising: updating the difference by applying a quantization or de-quantization process to the difference.

Clause 62. The method of any of clauses 56-61, further comprising: determining the reference model based on context information stored in a context parameter buffer.

Clause 63. The method of clause 62, further comprising: determining the reference model from the context parameter buffer based on at least one of: a context index, a quantization parameter (QP) index, a slice type index, or a temporal layer index.

Clause 64. The method of any of clauses 56-63, wherein the reference model comprises reference context information associated with at least one of: a quantization parameter (QP) of the at least one context model, a slice type of the at least one context model, or a temporal layer of the at least one context model.

Clause 65. The method of any of clauses 1-64, wherein the initiation information of the at least one context model is included in a first frame or slice, and the at least one context model is used in a second frame or slice.

Clause 66. The method of clause 65, wherein the first frame or slice is a reference frame of the second frame or slice.

Clause 67. The method of clause 66, wherein an association between the reference frame and the information of the at least one context model is included in the bitstream.

Clause 68. The method of clause 65 or clause 66, wherein at least one of a reference list or a reference index associated with the reference frame is included in the bitstream.

Clause 69. The method of any of clauses 1-68, wherein the conversion includes encoding the current video block into the bitstream.

Clause 70. The method of any of clauses 1-68, wherein the conversion includes decoding the current video block from the bitstream.

Clause 71. An apparatus for video processing comprising a processor and a non-transitory memory with instructions thereon, wherein the instructions upon execution by the processor, cause the processor to perform a method in accordance with any of clauses 1-70.

Clause 72. A non-transitory computer-readable storage medium storing instructions that cause a processor to perform a method in accordance with any of clauses 1-70.

Clause 73. A non-transitory computer-readable recording medium storing a bitstream of a video which is generated by a method performed by an apparatus for video processing, wherein the method comprises: determining, based on initiation information of at least one context model, the at least one context model associated with a current video block of the video, the initiation information of the at least one context model being included in the bitstream; and generating the bitstream based on the at least one context model.

Clause 74. A method for storing a bitstream of a video, comprising: determining, based on initiation information of at least one context model, the at least one context model associated with a current video block of the video, the initiation information of the at least one context model being included in the bitstream; generating the bitstream based on the at least one context model; and storing the bitstream in a non-transitory computer-readable recording medium.

### Example Device

FIG. 7 illustrates a block diagram of a computing device 700 in which various embodiments of the present disclosure can be implemented. The computing device 700 may be implemented as or included in the source device 110 (or the video encoder 114 or 200) or the destination device 120 (or the video decoder 124 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement video encoding/decoding in embodiments of the present disclosure. The memory 720 may include one or more video coding modules 725 having one or more program instructions. These modules are accessible and executable by the processing unit 710 to perform the functionalities of the various embodiments described herein.

In the example embodiments of performing video encoding, the input device 750 may receive video data as an input 770 to be encoded. The video data may be processed, for example, by the video coding module 725, to generate an encoded bitstream. The encoded bitstream may be provided via the output device 760 as an output 780.

In the example embodiments of performing video decoding, the input device 750 may receive an encoded bitstream as the input 770. The encoded bitstream may be processed, for example, by the video coding module 725, to generate decoded video data. The decoded video data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, at least one context model associated with the current video block based on initiation information of the at least one context model, the initiation information of the at least one context model being included in the bitstream; and
performing the conversion based on the at least one context model.

2. The method of claim 1, wherein the initiation information of the at least one context model comprises at least one of: a probability parameter, an updating speed of the probability parameter, an indicator of an initialized value of the probability parameter, or a further parameter associated with the at least one context model, and/or
wherein the initiation information of the at least one context model is included in a first video unit in the bitstream, wherein the first video unit comprises at least one of: a sequence parameter set (SPS), an adaptation parameter set (APS), a picture parameter set (PPS), a picture header, a slice header, a coding tree unit (CTU), a CTU line, a prefix APS, or a suffix APS.

3. The method of claim 2, wherein a first syntax element is included in the bitstream, the first syntax element indicating a type of information included in the first video unit,
wherein the first syntax element further indicates whether the initiation information of the at least one context model is included in the first video unit,
wherein if the first syntax element indicates the initiation information of the at least one context model, the initiation information is included in the first video unit, and/or
wherein at least one second syntax element indicating whether the first syntax element is included in the first video unit is included in at least one second video unit in the bitstream.

4. The method of claim 3, wherein the at least one second syntax element comprises a single second syntax element in a single second video unit,
wherein the first video unit comprises the picture parameter set (PPS), and the single second video unit comprises one of: the sequence parameter set (SPS), or a video parameter set (VPS),
wherein the single second syntax element indicates whether a first coding tool is enabled, the initiation information of the at least one context model being included in the first video unit by the coding tool, or wherein the single second syntax element indicates whether the initiation information of the at least one context model is included in the first video unit,
wherein the at least one second syntax element comprises a plurality of second syntax elements in a plurality of second video units, the plurality of second video units being different video units,
wherein one of the plurality of second syntax elements indicates whether a second coding tool is enabled, the initiation information of the at least one context model being included in the first video unit by the coding tool, and another one of the plurality of second syntax elements indicates whether the initiation information of the at least one context model is included in the first video unit, and/or
wherein a combination of the plurality of second syntax elements indicates whether the initiation information of the at least one context model is included in the first video unit.

5. The method of claim 2, wherein the first video unit comprises an extension part of the adaptation parameter set (APS),
wherein a first syntax element indicates whether the extension part of the APS exists is included in the bitstream, and/or
wherein if the first syntax element indicates that the extension part exists, the initiation information of the at least one context model is included in the extension part.

6. The method of claim 1, wherein if a coding tree unit (CTU) in a frame or a slice is coded, the initiation information of the at least one context model is included in the bitstream, the frame comprising a B frame or a P frame, the slice comprising a B slice or a P slice, and/or
wherein the CTU comprises at least one of: a last CTU in the frame or the slice, a central CTU in the frame or the slice, or a CTU in a predefined position in the frame or the slice.

7. The method of claim 1, wherein determining the at least one context model comprises:
initializing at least one context of the at least one context model based on the initiation information.

8. The method of claim 1, further comprising:
determining whether to include the initiation information of the at least one context model in the bitstream based on at least one syntax element in the bitstream,
wherein the at least one syntax element is in at least one video unit, the at least one video unit comprising at least one of: a sequence parameter set (SPS), a video parameter set (VPS), a picture parameter set (PPS), a picture header, or slice header, wherein the at least one syntax element indicates whether the at least one video unit comprises the initiation information of the at least one context model, and/or
wherein the initiation information of the at least one context model is included in a high-level syntax module, the high-level syntax module comprising at least one of: a picture parameter set (PPS), a picture header, or slice header, wherein the at least one syntax element in at least one of a sequence parameter set (SPS), a video parameter set (VPS) or a picture parameter set (PPS) indicates whether the initiation information of the at least one context model is included in the high-level syntax module.

9. The method of claim 1, further comprising:
storing context information of the at least one context model in a context parameter buffer,
wherein the context parameter buffer is in at least one of: an encoder associated with an encoding conversion from the current video block into the bitstream, or a decoder associated with a decoding conversion from the bitstream into the current video block,
wherein the context information comprises a plurality of sets of context parameters associated with the at least one context model, a set of context parameters comprising a plurality of contexts associated with a context model of the at least one context model,
wherein a number of the at least one context model is less than or equal to a number of the plurality of sets of the context parameters,
wherein the plurality of sets of context parameters comprises a first set of context parameter associated with a first quantization parameter (QP) and a second set of context parameter associated with a second QP,
wherein the plurality of sets of context parameters comprises a third set of context parameter associated with a first slice type and a fourth set of context parameter associated with a second slice type,
wherein the plurality of sets of context parameters comprises a fifth set of context parameter associated with a first temporal layer and a sixth set of context parameter associated with a second temporal layer,
wherein a single set of context parameters of the plurality of sets of context parameters is associated with at least one of: a first quantization parameter (QP), a first slice type, or a first temporal layer, and/or
wherein more than one of the plurality of sets of context parameters is associated with at least one of: a first quantization parameter (QP), a first slice type, or a first temporal layer.

10. The method of claim 9, wherein if a coding process of a current frame or a current slice is completed, the context information of at least a partial of context parameters of the at least one context model is included in the bitstream,
wherein the method further comprises: coding the context information of the at least partial of context parameters; and updating the context parameter buffer based on the context information, and/or
wherein the context information is used for initializing a context state of a subsequent frame subsequent to the current frame.

11. The method of claim 9, wherein no context information of the context model of the at least one context model is stored in the context parameter buffer, and/or
wherein the context parameter buffer comprises a reference context for a predictive context coding.

12. The method of claim 1, wherein the initiation information of the at least one context model is included for at least a partial of B frames, or at least a partial of P frames, wherein whether the initiation information of the at least one context model associated with a current slice or a current frame is included in the bitstream is based on at least one of: a quantization parameter (QP) value, a slice type, or a temporal layer index, and/or
wherein the initiation information of the at least one context model is included in the bitstream based on a picture order count (POC) interval, wherein the POC interval is predefined or determined during the conversion.

13. The method of claim 1, wherein if the initiation information of the at least one context model associated with a frame or a slice is included in the bitstream, at least a partial of context information in the frame or slice is included in the bitstream,
wherein the at least one context model comprises a first number of context models, a second number of context states is included in the bitstream, the second number being less than or equal to the first number,
wherein the method further comprises: sorting the first number of context models based on a metric; determining the second number of context models from the first number of context models based on the sorting; and including the second number of context states associated with the second number of context models in the bitstream,
wherein the second number is a same or different for a plurality of frames or a plurality of slices,
wherein if a context state of a context model of the at least one context model satisfies a condition, the context state is included in the bitstream,
wherein the second number is a predefined value, or is determined for the frame or the slice, and/or
wherein the second number of context states comprises a plurality of predefined contexts.

14. The method of claim 1, wherein if context information associated with a first context model is not included in the bitstream, a context state of the first context model is initialized based on a context based adaptive binary arithmetic coding (CABAC) context initialization table,
wherein context information associated with the at least one context model is included in the bitstream,
wherein the method further comprises: determining the initiation information of the at least one context model by using a predictive coding, and/or
wherein a coding process associated with the current video block is based on a parameter of a reference model, the context information of the at least one context model is included in the bitstream during the coding process.

15. The method of claim 1, wherein a difference between a first value of a context parameter of a reference model and a second value of the context parameter of a current context model of the at least one context model is included in the bitstream,
wherein the method further comprises at least one of:
determining the reference model based on a context based adaptive binary arithmetic coding (CABAC) context initialization table;
updating the difference by applying a quantization or de-quantization process to the difference; or
determining the reference model based on context information stored in a context parameter buffer and determining the reference model from the context parameter buffer based on at least one of: a context index, a quantization parameter (QP) index, a slice type index, or a temporal layer index,
wherein the difference is coded by at least one of: a truncated rice (TR) coding tool, a truncated binary (TB) coding tool, a k-th order exponential-Golomb (EGk) coding tool, or a fixed-length (FL) coding tool,
wherein the difference is coded by a context based adaptive binary arithmetic coding (CABAC), and/or
wherein the reference model comprises reference context information associated with at least one of: a quantization parameter (QP) of the at least one context model, a slice type of the at least one context model, or a temporal layer of the at least one context model.

16. The method of claim 1, wherein the initiation information of the at least one context model is included in a first frame or first slice, and the at least one context model is used in a second frame or second slice,
wherein the first frame or the first slice is a reference frame of the second frame or the second slice,
wherein an association between the reference frame and the initiation information of the at least one context model is included in the bitstream, and/or
wherein at least one of a reference list or a reference index associated with the reference frame is included in the bitstream.

17. The method of claim 1, wherein the conversion includes encoding the current video block into the bitstream, and/or
wherein the conversion includes decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, at least one context model associated with the current video block based on initiation information of the at least one context model, the initiation information of the at least one context model being included in the bitstream; and
perform the conversion based on the at least one context model.

19. A non-transitory computer-readable storage medium storing instructions that cause a processor to:
determine, for a conversion between a current video block of a video and a bitstream of the video, at least one context model associated with the current video block based on initiation information of the at least one context model, the initiation information of the at least one context model being included in the bitstream; and
perform the conversion based on the at least one context model.

20. A non-transitory computer-readable recording medium storing a bitstream of a video which is generated by a method performed by an apparatus for video processing, wherein the method comprises:
determining, based on initiation information of at least one context model, the at least one context model associated with a current video block of the video, the initiation information of the at least one context model being included in the bitstream; and
generating the bitstream based on the at least one context model.
